(19) United States
(12) Patent Application Publication
(10) Pub. No.: US 2023/0359879 A1
(43) Pub. Date: Nov. 9, 2023

(54) DIFFRACTIVE DEEP NEURAL NETWORKS WITH HARDWARE-SOFTWARE CO-DESIGN

(71) Applicant: University of Utah Research Foundation, Salt Lake City, UT (US)

(72) Inventors: Weilu Gao, Salt Lake City, UT (US); Cunxi Yu, Salt Lake City, UT (US)

(21) Appl. No.: 18/307,207

(22) Filed: Apr. 26, 2023

Related U.S. Application Data
(60) Provisional application No. 63/337,965, filed on May 3, 2022.

(51) Int. Cl. G06N 3/067; G06N 3/08

(52) U.S. Cl. CPC G06N 3/067; G06N 3/08

(57) ABSTRACT

A multipath deep diffractive neural network comprises a first optical path for performing a first task and a second optical path for performing a second task. The second task is different than the first task. The multipath deep diffractive neural network further comprises an overlap optical path where the first optical path and the second optical path overlap. The multipath deep diffractive neural network comprises one or more optical elements that are configured to create a multipath optical neural network that performs a plurality of different tasks using multi-task machine learning.

### CROSS-REFERENCE TO RELATED APPLICATIONS

This application claims the benefit of and priority to U.S. Provisional Patent Application Ser. No. 63/337,965 filed on 3 May 2022 and entitled “DIFFRACTIVE DEEP NEURAL NETWORKS WITH HARDWARE-SOFTWARE CO-DESIGN,” which application is expressly incorporated herein by reference in its entirety.

### BACKGROUND

Computers and computing systems have affected nearly every aspect of modern living. Computers are generally involved in work, recreation, healthcare, transportation, entertainment, household management, etc. Over the last several years, artificial intelligence, and in particular deep learning, has experienced a significant increase in interest and capability.

Deep learning is a machine learning method that can achieve data representation, abstraction, and advanced tasks by simulating a multi-layer artificial neural network in a computer. Deep learning has made inroads to computer vision, voice/image recognition, robotics, and other applications. However, electronic and active deep learning is limited by the von Neumann architecture regarding processing time and energy consumption. In the last several decades, optical information processing, which implements the operations of convolution, correlation, and Fourier transformation in an optical system, has been found to exhibit unique advantages for parallel processing and has been widely investigated. Computer-based deep learning has been achieved in optical systems by using diffractive optical elements, and optical deep learning based on diffractive optical elements has been validated using image classification.

As deep diffractive neural networks (D²NN) have emerged for optical deep learning, issues in high power consumption and data throughput bottlenecks remain. There remains a need for improved energy efficiency and high-throughput in these optical, multiple task machine learning systems.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments comprise a multipath deep diffractive neural network. The multipath deep diffractive neural network comprises a first optical path for performing a first task and a second optical path for performing a second task. The second task is different than the first task. The multipath deep diffractive neural network further comprises an overlap optical path where the first optical path and the second optical path overlap. The multipath deep diffractive neural network comprises one or more optical elements that are configured to create a multipath optical neural network that performs a plurality of different tasks using multi-task machine learning.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of the system architecture of a multipath optical neural network.

FIG. 2 illustrates an example real-time multi-task diffractive deep neural network (D2NN) architecture.

FIG. 3 illustrates a proposed approach for producing the classes, which re-use the detectors for two different tasks.

FIG. 4 illustrates a flowchart for a method for using a multipath deep diffractive neural network.

### DETAILED DESCRIPTION

Embodiments of deep diffractive neural networks (D²NN) disclosed herein provide for a hardware/software co-design method and system that enables real-time multi-task learning in D²NNs that automatically recognizes which task is being deployed in real-time. Disclosed embodiments may provide significant improvements in versatility and hardware efficiency. The resulting reduced power consumption and increased data throughput provides significant benefits in many fields that process large quantities of data in real-time, especially utilizing machine learning in computer vision applications.

Disclosed embodiments can automatically recognize which task is being deployed and generate corresponding predictions in a real-time fashion, without any external inputs in addition to the input images. The proposed hardware-software co-design approach may significantly reduce the complexity of the hardware by further reusing the detectors and maintaining robustness under multiple system noises. Lastly, an efficient domain-specific regularization algorithm for training multi-task D²NNs may offer flexible control to balance the prediction accuracy of each task (task accuracy trade-off) and prevent over-fitting. The application's multi-task D²NNs system can achieve the same accuracy for both tasks compared to original D²NNs with an above 75% improvement in hardware efficiency. Disclosed embodiments are resilient under detector Gaussian noise and fabrication variations, where prediction performance degrades <1% within practical noise ranges.

A D²NN is a type of neural network architecture that incorporates diffractive optical elements (DOEs) into the network's layers. DOEs are structures that manipulate light waves, allowing them to bend and diffract in specific ways. By using DOEs in a neural network, the network can perform complex mathematical operations in parallel, with lower energy consumption and faster processing times than traditional computing methods.

In a D²NN, each layer consists of a DOE that is designed to manipulate the input signal in a particular way. The output of one layer serves as the input to the next layer, allowing the network to perform increasingly complex calculations. The DOE can be designed to perform a variety of mathematical operations, such as convolution, Fourier transforms, and correlation.

One of the advantages of a D²NN is that it can be trained using backpropagation, just like a traditional neural network. However, the training process for a D²NN requires additional considerations, such as the design of the DOEs and the optimization of the light propagation through the network.

The optical elements for a D²NN can be made using a variety of manufacturing techniques, depending on the specific design requirements and material properties. For example, one common method for creating diffractive optical elements is lithography, which involves using a patterned mask to transfer a design onto a substrate. The substrate can be made of materials such as glass, quartz, or plastic, and the patterned mask can be created using techniques such as electron beam or laser writing. The resulting patterned substrate can then be coated with a thin film to enhance its optical properties. Another example method for creating optical elements is 3D printing, which may allow for more complex and customized designs. Using a technique called direct laser writing, a laser may be used to selectively solidify a photosensitive polymer in a specific pattern, which can then be coated with a thin film to improve its optical performance. In addition to these methods, optical elements for deep diffractive neural networks can also be fabricated using techniques such as holography, photolithography, and nanoimprint lithography. Additionally, spatial light modulators made from graphene may offer ultrahigh data throughput and ultralow energy consumption to perform the operations in DOEs.

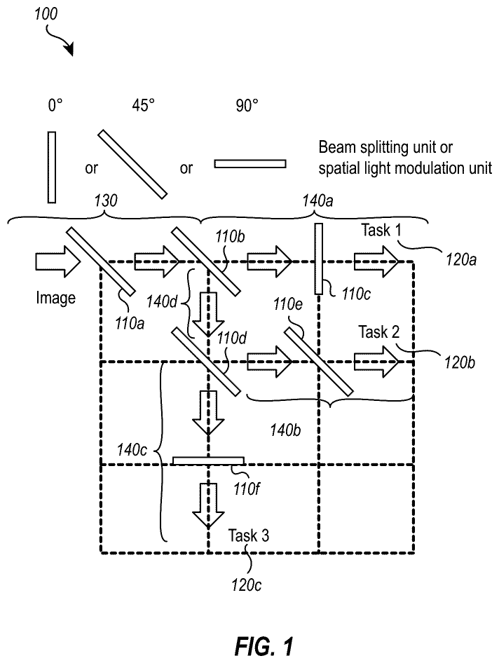

In at least one embodiment a multipath optical neural network (MPONN) that can fulfill real-time multi-task machine learning with particular focuses on Computer Vision (CV) applications, in an energy-efficient and high-throughput manner. For example, FIG. 1 displays an example embodiment of the system architecture of a MPONN 100. The network grid is scalable for any size. The input image is generated by coherent light. Optical elements 110(a-f), such as passive beam splitting unit (e.g., optical beam splitters) or active spatial light modulation unit can be placed on each grid point. In the depicted embodiment, the optical elements provide three choices of orientations 0, 45, and 90 degrees. Active spatial light modulation units can be programmed (e.g., by controlling applied voltages) to regulate the light complex transmission and reflection coefficients. Optical diffraction from the optical elements 110(a-f) creates interconnects between pixels in adjacent layers, which can implement neural networks for objective detection, classification, and segmentation. In various embodiments, spatial light modulation units can be commercial ones, including liquid crystal-based technology and digital micromirrors, as well as emerging ones made from new nanomaterials, such as graphene. As depicted, since both reflection and transmission are utilized, the system loss is minimized. In particular, FIG. 1 shows one possible configuration for three different tasks 120(a-c). Accordingly, in this non-limiting example, three tasks classification can be done in a single camera or multiple cameras, by training each programmable spatial light modulation unit.

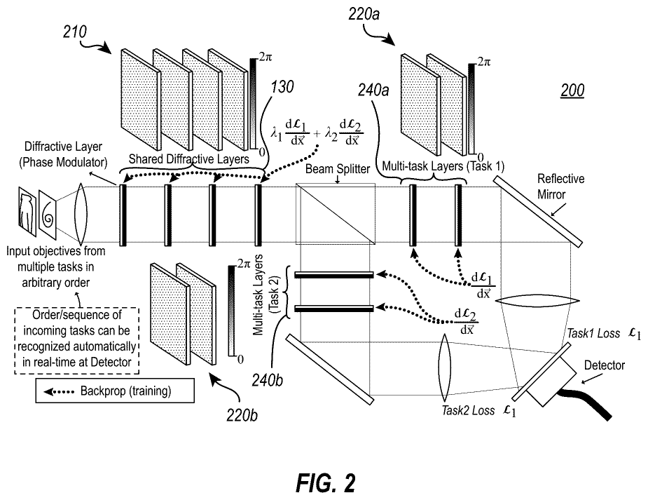

FIG. 2 depicts an embodiment of a real-time multi-task D²NN. Specifically, in this embodiment, then multi-task D²NN deploys image classification DNN algorithms with two tasks, i.e., classifying MNIST10 dataset and classifying Fashion-MNIST10 dataset. In a single-task D²NN architecture for classification, the number of opto-electronic detectors positioned at the output of the system may be equal to the number of classes in the target dataset. The predicted classes are generated similarly as conventional DNNs by selecting the index of the highest probability of the outputs (argmax), i.e., the highest energy value observed by detectors.

Let the D²NN multi-task learning problem over an input space X, a collection of task spaces [symbol] _{n∈[0,N]}ⁿ, and a large dataset including data points {xᵢ, yᵢ¹, . . . , yᵢ^{N}}_{I}∈[D], where N is the number of tasks and D is the size of the dataset for each task. The hypothesis for D²NN multi-task learning remains the same as conventional DNNs, which generally yields the following empirical minimization formulation:

$${min}_{{θ}^{share} {θ}^{1} , {θ}^{2} , … , {θ}^{N}} {\sum }_{n = 1}^{N} {c}^{t} ℒ ( {θ}^{share} , {θ}^{t} ) \qquad Equation 1$$

where [symbol] is a loss function that evaluates the overall performance of all tasks. The finalized multi-task D²NN will deploy the mapping, f(x, θ^{share}, θⁿ):χ→ [symbol] ⁿ, where θ^{share} are shared parameters in the shared diffractive layers between tasks and task-specific parameters θⁿ included in multi-task diffractive layers. Note that the depicted system 200 includes four shared diffractive layers (θ^{share}) 210 and one multi-task diffractive layer 220a, 220b for each of the two tasks. The multi-task mapping function becomes f (x, θ^{share}, θ^{1,2}):χ→ [symbol] ², and can be then decomposed into:

$$f ( x , {θ}^{share} , {θ}^{1 , 2} ) = det ( {f}^{1} ( \frac{1}{2} \cdot {f}^{share} ( x , {θ}^{share} ) , {θ}^{1} ) + {f}^{2} ( \frac{1}{2} \cdot {f}^{share} ( x , {θ}^{share} ) , {θ}^{2} ) ) \qquad Equation 2$$

$$\\ \begin{matrix}{f}^{share} : 𝒳 \to {( ℛ + 𝒥 )}^{∈ 200 \times 200} , {f}^{1} , \text{} {f}^{2} : {( ℛ + 𝒥 )}^{∈ 200 \times 200} \to {( ℛ + 𝒥 )}^{∈ 200 \times 200} & Equation 3\end{matrix}$$

where f^{share}, f¹, and f² produce mappings in complex number domain that represent light propagation in phase modulated photonics. The output det∈ [symbol] ^{C×1} are the readings from C detectors, where C is the largest number of classes among all tasks; for example, C=10 for MNIST and Fashion-MNIST. The proposed multitask D²NN system is constructed by designing six phase modulators based on the optimized phase parameters in the four shared layers 210 and two multi-task layers 220a, 220b. The phase parameters can be optimized with backpropogation with gradient chain-rule applied on each phase modulation and adaptive momentum stochastic gradient descent algorithm (Adam). The design of phase modulators can be done with 3D printing or lithography to form a passive optical network that performs inference as the input light diffracts from the input plane to the output. Alternatively, such diffractive layer models can also be implemented with spatial light modulators (SLMs), which offers the flexibility of reconfiguring the layers with the cost of limiting the throughput and increase of power consumption.

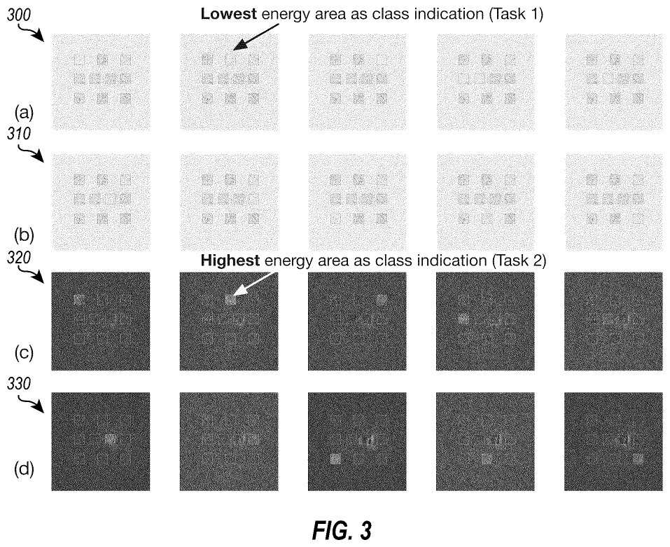

FIG. 3 illustrates the proposed approach for producing the classes, which re-use the detectors for two different tasks. In a simplified embodiment, given two tasks and each task having 4 classes, the system uses [10 0 0] to represent class-0 of task 1 and [0 1 1 1] to represent class-0 for task 2. Similarly, [0 10 0] [0 0 1 0] [0 0 0 1] represent class-1/2/3 for task 1, and [1 0 1 1] [1 1 0 1] [1 1 1 0] represent class-1/2/3 for task 2. Therefore, when the system captures one-hot results, it knows that is from task 1; otherwise, it will be task 2.

Specifically, in FIG. 3, for the multi-task D²NN evaluated in this work, both MNIST and Fashion-MNIST have ten classes. Thus, all the detectors used for one class can be fully re-utilized for the other. To enable an efficient training process, we use one-hot encodings for representing the classes similarly as the conventional multi-class classification ML models. In at least one embodiment, the novel modeling introduced in this work that enables re-using the detectors is—defining “1” differently in the one-hot representations. As shown in rows 300 and 310, for the first task MNIST, the one-hot encoding for classes 0-9 is presented, where each bounding box includes energy values observed at the detectors. In which case, “1” in the one-hot encoding is defined as the lowest energy area, such that the label can be generated as argmin(det)—the index of the lowest energy area. Similarly, rows 320 and 330 are the one-hot encodings for classes 0-9 of the second task Fashion-MNIST, where the label is the index of the highest energy area, i.e., argmax(det). As such, in at least one embodiment, ten detectors can be used to generate the final outputs for two different tasks that share the same number of classes, to gain an extra 55% and 50% hardware efficiency of the proposed multi-task D²NN.

In multi-task learning, it is often needed to adjust the weight or importance of different prediction tasks according to the application scenarios. For example, one task could be required to have the highest possible prediction performance while the performance of other tasks is secondary. To enable such biased multi-task learning, the shared representations θ share need to carefully adjusted. In at least one embodiment, the system can adjust the performance of different tasks using a novel domain-specific regularization function shown in Equation 4, where λ₁ and λ₂ are used to adjust the task importance, with a modified L2 normalization applied on multi-task layers only. The loss regularization may be sufficient to enable biased multi-task learning in the proposed multi-task D²NN architecture, regardless of the initialization and training setups.

$$ℒ ( {θ}^{share} , {θ}^{1 , 2} ) + \underbrace{{λ}_{1}}_{t 1 factor} {ℒ}_{1} ( {θ}^{share} , {θ}^{1} ) + \underbrace{{λ}_{2}}_{t 2 factor} \cdot {ℒ}_{2} ( {θ}^{share} , {θ}^{2} ) + {\underbrace{{λ}_{L 2} \frac{{λ}_{2}}{{λ}_{1}} \cdot ( {( {θ}^{1} )}^{2} + ( {( {θ}^{2} )}^{2}}}_{adjusted L 2 norm} \qquad Equation 4$$

Returning now to FIG. 2, an embodiment of multi-task D²NN architecture is depicted. Based on the phase parameters θ^{share}, θ¹, and θ², there several options to implement the diffractive layers to build the multi-task D²NN system. For example, the passive diffractive layers can be manufactured using 3D printing for long-wavelength light (e.g. terahertz) or lithography for short-wavelength light (e.g. near-infrared), and active reconfigurable ones can be implemented using spatial light modulators. A 50-50 beam splitter may be used to split the output beam from the last shared diffractive layer into two ideally identical channels for multi-task layers. Coherent light source, such as laser diodes, can be used in this system. At the output of two multi-task layers, the electromagnetic vector fields are added together on the detector plane. The generated photocurrent corresponding to the optical intensity of summed vector fields is measured and observed as output labels.

Regarding the real-time capability of the described embodiment, the time of light flight is negligible and the determination factor for system hardware performance is dependent on the performance of THz detectors. For a detector with operation bandwidth f, the corresponding latency is 1/f and the largest throughput is f frames/s/task. The minimum power requirement for this system is determined by the number of detectors, NEP (noise-equivalent-power), if we assume the loss and energy consumption associated with phase masks is negligible. In practice, considering a room-temperature VDI detector operating 2 at ˜0.3 THz, f=˜40 GHz, and NEP=2.1 pW/ [symbol] , the latency of the system will be 25 ps, throughput is 4×10 \hat{ }10 fps/task (frame/second/task), with power consumption 0.42 uW. In addition to mitigate the large cost of detectors, alternative materials can be used, such as graphene.

Disclosed embodiments include a multipath D²NN. Examples of such a D²NN 100, 200 are shown in FIGS. 1 and 2. The D²NN may comprise a first optical path 240a for performing a first task. The first task may be accomplished using the one or more multi-task diffractive layers 220a. The D²NN may further comprise a second optical path 240b for performing a second task using the one or more multi-task diffractive layers 220b. As used herein, the second task is different than the first task. In the depicted embodiment, the D²NN 200 further comprises an overlap optical path 230 where the first optical path 240a and the second optical path 240b overlap. The overlap optical path 230 utilizes shared diffractive layers (θ^{share}) 210 that are configured for more than one task. For example, the one or more shared diffractive layers 210 that are located on the overlap optical path 230 may be configured to be used within both the first task and the second task.

The various optical paths may comprise one or more optical elements (e.g., diffractive layers 210, 220a,220b). The one or more optical elements 210, 220a, 220b may be configured to create a multipath optical neural network that performs a plurality of different tasks using multi-task machine learning. For example, the one or more optical elements 210, 220a, 220b may be configured to select a choice of orientation from a group consisting of 0, 45, and 90 degrees. The one or more optical elements 210, 220a, 220b may comprise one or more of passive beam splitters and/or active spatial light modulators. Additionally, the one or more optical elements may comprise nanomaterials, such as graphene.

As used herein, the use of reflections within different optical paths is referred to as “reflection harvesting.” For example, as depicted in FIG. 1, an optical element (e.g., 110b) positioned at an end of an overlap optical path 130 may be configured to transmit a signal along the first optical path 140a and reflect the signal along the second optical path 140b. FIG. 2 further shows one or more first diffractive layers 220a positioned along the first optical path 240a. The one or more first diffractive layers 220a are configured to be used within the first task. One or more second diffractive layers 220b are positioned along the second optical path 240b. The one or more second diffractive layers 220b are configured to be used within the second task. As shown in FIG. 1, a third optical path 140c for performing a third task may also be utilized. The third task may be different than the first task and the second task. A secondary overlap optical path 140d is also depicted. This secondary overlap optical path 140d is shared between task 2 and task 3, but it not shared with task one. One will appreciate that any number of optical paths and overlap portions may be utilized in additional or alternative embodiments without straying from the disclosure presented herein.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

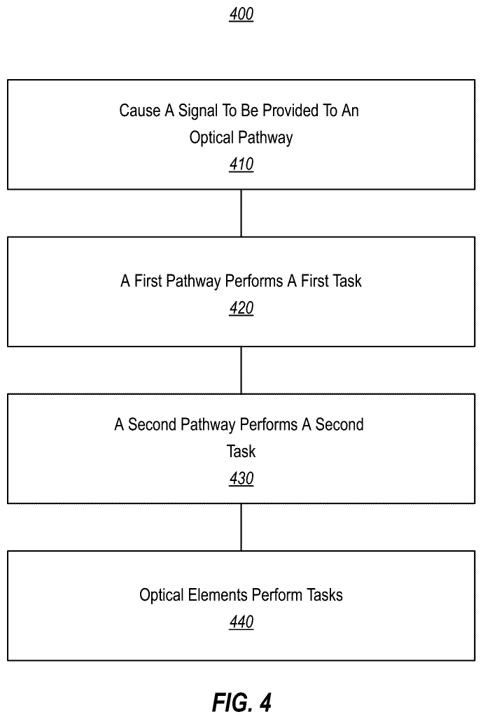

Referring now to FIG. 4, a method 400 is illustrated. Method 400 includes a step 410 of causing a signal to be provided to an optical pathway (e.g., 140a, 140b, 140c, 140d). Step 410 comprises causing a signal to be provided to an overlap optical path 230 where a first optical path 240a and a second optical path 240b overlap. Method 400 further includes a step 420 of a first pathway performing a first task. Step 420 comprises the first optical path is configured to perform a first task. For example, FIG. 3 depicts a describes processes utilized in performing a first task of classifying MNIST images.

Additionally, Method 400 includes a step 430 of a second pathway performing a second task. Step 430 comprises the second optical path is configured to perform a second task, wherein the second task is different than the first task. For example, FIG. 3 depicts a describes processes utilized in performing a second task of classifying Fashion-MNIST images.

Method 400 also includes a step 440 of optical elements performing tasks. Step 440 comprises one or more optical elements are configured to create a multipath optical neural network that performs a plurality of different tasks using multi-task machine learning.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A multipath deep diffractive neural network comprising:
a first optical path for performing a first task;
a second optical path for performing a second task, wherein the second task is different than the first task;
an overlap optical path where the first optical path and the second optical path overlap;
one or more optical elements; and
wherein the one or more optical elements are configured to create a multipath optical neural network that performs a plurality of different tasks using multi-task machine learning.

2. The multipath deep diffractive neural network of claim 1, wherein the one or more optical elements are configured to select a choice of orientation from a group consisting of 0, 45, and 90 degrees.

3. The multipath deep diffractive neural network of claim 1, wherein the one or more optical elements comprise nanomaterials.

4. The multipath deep diffractive neural network of claim 1, wherein the one or more optical elements comprise one or more of passive beam splitters and active spatial light modulators.

5. The multipath deep diffractive neural network of claim 1, wherein the multipath deep diffractive neural network is configured to perform reflection harvesting.

6. The multipath deep diffractive neural network of claim 5, further comprising:
one or more shared diffractive layers located on the overlap optical path, wherein the one or more shared diffractive layers are configured to be used within the first task and the second task.

7. The multipath deep diffractive neural network of claim 6, further comprising:
an optical element positioned at an end of the overlap optical path, wherein the optical element is configured to transmit a signal along the first optical path and reflect the signal along the second optical path.

8. The multipath deep diffractive neural network of claim 7, further comprising:
one or more first diffractive layers positioned along the first optical path, wherein the one or more first diffractive layers are configured to be used within the first task.

9. The multipath deep diffractive neural network of claim 8, further comprising:
one or more second diffractive layers positioned along the second optical path, wherein the one or more second diffractive layers are configured to be used within the second task.

10. The multipath deep diffractive neural network of claim 1, further comprising:
a third optical path for performing a third task, wherein the third task is different than the first task and the second task.

11. A method for using a multipath deep diffractive neural network comprising:
causing a signal to be provided to an overlap optical path where a first optical path and a second optical path overlap, wherein:
the first optical path is configured to perform a first task,
the second optical path is configured to perform a second task,
wherein the second task is different than the first task, and
one or more optical elements are configured to create a multipath optical neural network that performs a plurality of different tasks using multi-task machine learning.

12. The method as recited in claim 11, wherein the one or more optical elements are configured to select a choice of orientation from a group consisting of 0, 45, and 90 degrees.

13. The method as recited in claim 11, wherein the one or more optical elements comprise nanomaterials.

14. The method as recited in claim 11, wherein the one or more optical elements comprise one or more of passive beam splitters and active spatial light modulators.

15. The method as recited in claim 11, wherein the multipath deep diffractive neural network is configured to perform reflection harvesting.

16. The method as recited in claim 11, wherein one or more shared diffractive layers are located on the overlap optical path, wherein the one or more shared diffractive layers are configured to be used within the first task and the second task.

17. The method as recited in claim 16, wherein an optical element positioned at an end of the overlap optical path transmits a signal along the first optical path and reflect the signal along the second optical path.

18. The method as recited in claim 17, wherein one or more first diffractive layers are positioned along the first optical path, wherein the one or more first diffractive layers are configured to be used within the first task.

19. The method as recited in claim 18, wherein one or more second diffractive layers are positioned along the second optical path, wherein the one or more second diffractive layers are configured to be used within the second task.

20. The method as recited in claim 11, further comprising:
a third optical path for performing a third task, wherein the third task is different than the first task and the second task.
